(19) United States
(12) Patent Application Publication
(10) Pub. No.: US 2007/0194916 A1
(43) Pub. Date: Aug. 23, 2007

(54) Universal quick mount wireless door sensor and method

(75) Inventors: Gordon S. Hewitt, Trabuco Canyon, CA (US); Peter S. Lauenstein, La Canada, CA (US)

Correspondence Address: HARNESS DICKEY & PIERCE, PLC, P.O. BOX 828, BLOOMFIELD HILLS, MI, 48303, US

(73) Assignee: The Boeing Company, Chicago, IL (US)

(21) Appl. No.: 11/357,799

(22) Filed: Feb. 17, 2006

(51) Int. Cl. G08B 13/08; G08B 21/00

(52) U.S. Cl. 340/545.6; 340/686.1

(57) ABSTRACT

A container includes an enclosure portion, a door moveable from a closed position to an open position relative to the enclosure portion, and a sensing apparatus. The sensing apparatus includes a signal-emitting device providing a first wireless signal and having a first mounting structure non-invasively mounted to one of the enclosure portion and door. The sensing apparatus further includes a wireless sensing device including a sensing element configured to sense the first signal and a second mounting structure non-invasively mounted to the other of the enclosure portion and door. The sensing element is able to sense the first wireless signal when the door is in the closed position, and thus determine when the door is opened and closed. The signal emitting device and sensing device may each be releasably secured via adhesives so they can be used with different containers.

### FIELD OF THE INVENTION

The present invention relates to cargo security sensors, and more specifically to mounting of cargo security sensors.

### BACKGROUND OF THE INVENTION

Traditionally, security devices for containers have included mechanical devices such as locks. These security devices have evolved over time to include more complicated devices having a variety of additional features such as sensors and systems for communicating when the sensor detects a breach of the container. Typically, all of these security devices have been fixed to the containers in some manner. More specifically, these security devices are typically bolted to or secured to the containers in a manner not allowing for easy removal and movement and mounting to an alternate container. These security devices typically have a wired connection to a security unit. This wired connection not only requires a complicated routing of cables, but also requires a physical coupling between the security device and the security unit. With increasing security requirements for transported packages, the need for being able to move security devices between containers has grown in importance. This allows for added flexibility in the use of the devices, such as easy and quick installation and removal, while not requiring invasive mounting to the containers that the devices are coupled to.

### SUMMARY OF THE INVENTION

A container includes a first body member, a second body member moveable from a closed position to an open position relative to the first body member, and a sensing apparatus. The sensing apparatus includes a signal-emitting device providing a first signal and having a first mounting structure non-invasively mounted to one of the first and second body members. The sensing apparatus further includes a wireless sensing device including a sensing element configured to sense the first signal and a second mounting structure non-invasively mounted to the other of the first and second body members such that the sensing element is able to sense the first signal when the first body member is in the closed position. The signal emitting device and sensing device may each be releasably secured via adhesives so they can be used with different containers.

Further areas of applicability of the present invention will become apparent from the detailed description provided hereinafter. It should be understood that the detailed description and specific examples, while indicating various preferred embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of a container including the sensor of the present disclosure in an open position;

FIG. 2 is a schematic view of the container of FIG. 1 in a closed position;

FIG. 3 is a schematic end view of the sensor of FIG. 1;

FIG. 4 is a schematic view of the sensor of FIG. 1;

FIG. 5 is a schematic view of a container including an alternate sensor arrangement in an open position; and

FIG. 6 is a schematic view of the container of FIG. 5 in a closed position.

### DETAILED DESCRIPTION OF THE PREFERRED EMBODIMENTS

The following description of the preferred embodiments is merely exemplary in nature and is in no way intended to limit the invention, its application, or uses.

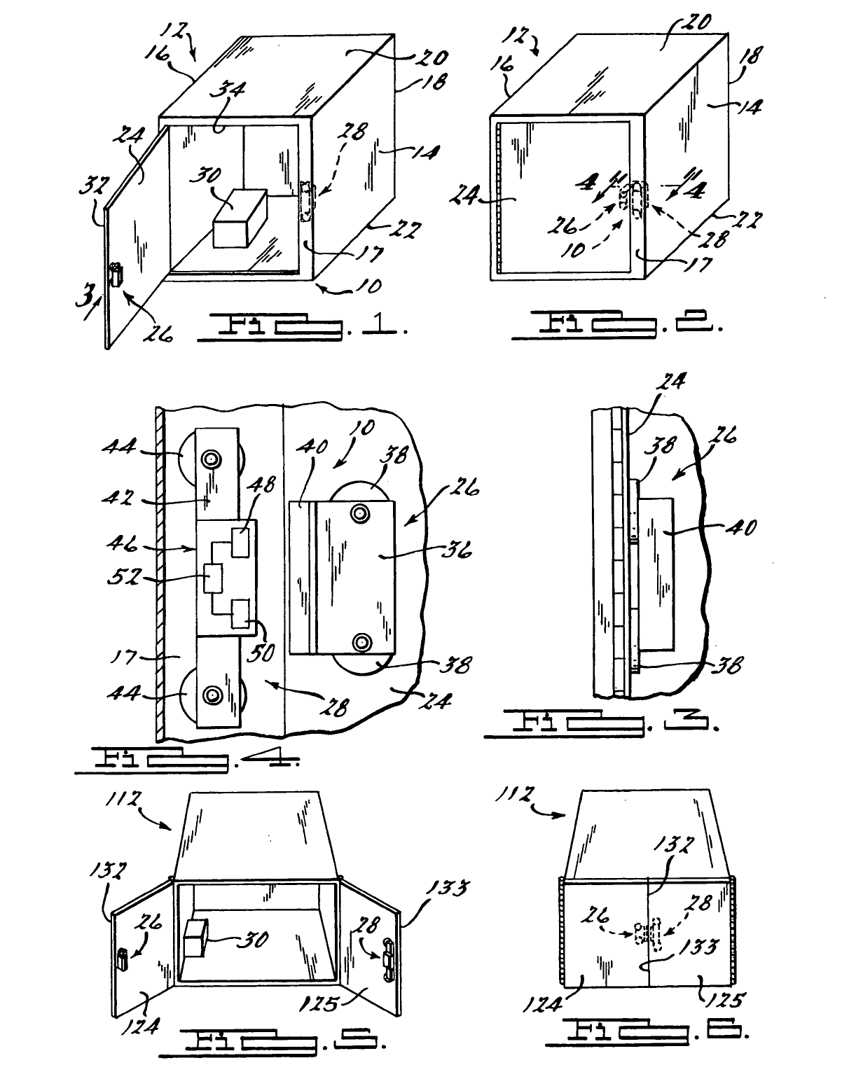

As seen in FIGS. 1 and 2, a security device 10 is generally shown coupled to a container 12. Container 12 may generally include side, front, and rear walls 14, 16, 17, 18, and upper and lower portions 20, 22. A door 24 is formed in front wall 17. Security device 10 may include a signal-emitting device 26, a wireless sensing device 28, and a container security unit 30. Portions 14, 16, 17, 18, 20 and 22 of the container 12 can be viewed as forming a container enclosure portion. The door 24 is moveably supported by any suitable means, for example, one or a pair of hinges.

Signal-emitting device 26 may be mounted to container door 24 at or near free end 32. Wireless sensing device 28 may be mounted to container front wall 17 at or near opening 34, or to any area of the container 12 where device 26 will be in proximity to where the door 24 is closed, such as sidewall 14. Signal-emitting device 26 and wireless sensing device 28 are mounted in a manner such that when door 24 is in an open position (shown in FIG. 1), signal-emitting device 26 is displaced from wireless sensing device 28, and when door 24 is in a closed position (shown in FIG. 2), signal emitting device 26 is in close proximity to wireless sensing device 28.

As seen in FIGS. 3 and 4, signal-emitting device 26 may include a mounting bracket 36 having coupling elements 38 attached thereto providing an engagement with door 24. Coupling elements 38 may include a variety of non-invasive attachment mechanisms such as magnets, adhesive materials, and suction mechanisms. Non-invasive attachment mechanisms may generally include all forms of attachment not requiring holes in container 12 for passage of bolts or screws therethrough. Signal-emitting device 26 also includes a signal-emitting portion 40. Signal-emitting portion 40 may be in the form of a magnet emitting a magnetic field.

Wireless sensing device 28 may include a mounting bracket 42 having coupling elements 44 attached thereto providing engagement with front wall 14 in a manner similar to that shown regarding signal-emitting device 26 and door 24 in FIG. 4. Coupling elements 44 may include a variety of non-invasive attachment mechanisms such as magnets, adhesive materials, and suction mechanisms. Wireless sensing device 28 includes a mechanism 46 having a sensing element 48 for sensing the signal (such as a magnetic field) provided by signal-emitting portion 40 of signal-emitting device 26, a wireless transmitter 50, and a processing circuit 52. Alternatively, sensing element 48 may sense other inputs, such as light, temperature, and/or vibration. These other inputs may be from signal-emitting portion 40 and/or from the environment near sensing element 48.

Wireless transmitter 50 is capable of transmitting a wireless signal, for example an electromagnetic wave signal, a magnetic field signal, a radio frequency (RF) signal, or possibly even an optical signal. Merely for exemplary purposes, the transmitter 50 will be described as generating an RF signal. Processing circuit 52 is in communication with sensing element 48 and wireless transmitter 50 and causes the RF signal to be transmitted when the sensing element 48 fails to sense the signal (such as a magnetic field) provided by signal-emitting portion 40 of signal-emitting device 26. The RF signal is transmitted to the container security unit 30.

Some countries may have regulations related to RF signal transmission. For example, in Japan unlicensed transmitters are allowed below 322 Mhz with 500 μV/m field strength of 3 meters. If a transmitter is initially above a desired threshold, it may be desirable to attenuate the signal. In order to attenuate the RF signal, a metallic material, such as foil tape may be used to cover all or a portion of wireless transmitter 50.

Container security unit 30 may be located within container 12 as shown in FIG. 1. Alternatively, a similar device may be located remotely from container 12, allowing remote notification of container open/close status. Container security unit 30 may record open/close events of container 12 and may also include an alarm that activates when container 12 is opened. Due to the wireless nature of wireless sensing device 28, the need for a cable connection between container security unit 30 and wireless sensing device 28 is eliminated.

In an alternative arrangement shown in FIGS. 5 and 6, container 112 may include first and second doors 124, 125. Signal-emitting device 26 is mounted to first door 124 near free end 132. Wireless sensing device 28 is mounted to second door 125 near free end 133. As mentioned above regarding container 12, container security unit 30 may be located within container 112. Signal-emitting device 26 and wireless sensing device 28 are mounted in a manner such that when either or both of doors 124, 125 are in an open position (shown in FIG. 5), signal-emitting device 26 is displaced from wireless sensing device 28. When doors 124, 125 are in a closed position (shown in FIG. 6), signal-emitting device 26 is positioned generally adjacent wireless sensing device 28.

It is understood that a number of additional configurations may be used in addition to those already described regarding containers 12, 112. Signal-emitting device 26 may be mounted to a first portion of the container structure, such as a container lid, moveable relative to a second portion of the container structure having wireless sensing device 28 mounted thereto. Also, while signal-emitting device 26 has been described as being mounted to a moveable structure, such as the first portion of the container structure noted above, it is understood that wireless sensing device 28 may be mounted to a moveable structure instead. For example, referring to FIG. 1, signal-emitting device 26 may be mounted to container front wall 17 and wireless sensing device 28 may be mounted to door 24.

It is also understood that containers 12, 112 may be any of a variety of containers. More specifically, containers 12, 112 may be shipping containers. Containers 12, 112 may additionally be capable of operating in a maritime environment or in aerospace applications.

While various preferred embodiments have been described, those skilled in the art will recognize modifications or variations which might be made without departing from the inventive concept. The examples illustrate the invention and are not intended to limit it. Therefore, the description and claims should be interpreted liberally with only such limitation as is necessary in view of the pertinent prior art.

What is claimed is:

1. An apparatus for a container having a first member and a second member, one of the first and second members being moveable from a closed position to an open position relative to the other of the first and second members, said apparatus capable of detecting the position of the first member, said apparatus comprising:
a signal-emitting device providing a first signal, said signal-emitting device having a first mounting structure configured to non-invasively mount said signal-emitting device to the first member; and
a wireless sensing device including a sensing element configured to sense said first signal and a second mounting structure configured to non-invasively mount said wireless sensing device to the second member so that said sensing element is able to sense said first signal and detect a position of the first member relative to the second member.

2. The apparatus of claim 1, wherein one of said mounting structures includes a magnetic element having a magnetic field capable of securing it to one of the first and second members.

3. The apparatus of claim 1, wherein one of said first mounting structure and said second mounting structure includes an adhesive element capable of securing it to one of the first and second members.

4. The apparatus of claim 1, wherein one of said mounting structures includes a suction element producing a suction capable of securing it to one of the first and second members.

5. The apparatus of claim 1, wherein said signal-emitting device includes a magnet providing said first signal as a magnetic field, said wireless sensing device being able to sense said magnetic field.

6. The apparatus of claim 1, wherein said wireless sensing device includes a wireless transmitter configured to transmit a second signal and a processing circuit in communication with said sensing element and said wireless transmitter, said processing circuit configured to cause said second signal to be transmitted when said sensing element fails to detect said first signal.

7. The apparatus of claim 1, wherein said non-invasive mounting of said first and second mounting structures comprises a releasable mounting.

8. A container comprising:
a first body member;
a second body member moveable from a closed position to an open position relative to said first body member; and
a sensing apparatus including:
a signal-emitting device providing a first signal, said signal-emitting device having a first mounting structure non-invasively mounted to one of said first and second body members; and
a wireless sensing device including a sensing element configured to sense said first signal and a second mounting structure non-invasively mounted to the other of said first and second body members, said sensing element configured to sense said first signal when said first member is in the closed position.

9. The container of claim 8, wherein said first body member is a frame member.

10. The container of claim 9, wherein said wireless sensing device is coupled to said frame member.

11. The container of claim 8, wherein said second body member is a first container door.

12. The container of claim 11, wherein said signal-emitting device is coupled to said first container door.

13. The container of claim 11, wherein said first body member is a second container door.

14. The container of claim 8, wherein one of said mounting structures includes a magnetic element having a magnetic field for securing it to one of said first and second body members.

15. The container of claim 8, wherein one of said mounting structures includes an adhesive element for securing it to one of said first and second body members.

16. The container of claim 8, wherein one of said mounting structures includes a suction element for securing it to one of said first and second members.

17. The container of claim 8, wherein said signal-emitting device includes a magnet providing a magnetic field, said wireless sensing device configured to sense said magnetic field.

18. The container of claim 8, wherein said wireless sensing device includes a wireless transmitter configured to transmit a second signal and a processing circuit in communication with said sensing element and said wireless transmitter, said processing circuit configured to cause said second signal to be transmitted when said sensing element fails to detect said first signal.

19. The container of claim 8, wherein said non-invasive mounting of said first and second mounting structures comprises a releasable mounting component for each of said structures.

20. A method for monitoring the position of a door of a container relative to an enclosure portion of the container, from which the door is supported, the method comprising:
securing a first sensing component to a portion of said enclosure portion at a position in proximity to said door;
securing a second sensing component to said door at a position in proximity to a portion of said enclosure portion when said door is in a closed position;
causing one of the sensing components to generate a wireless signal;
using the other one of the sensing components to detect for reception of the wireless signal; and
from the detection or non-detection of said wireless signal, determining a position of said door relative to said enclosure portion of the container.

21. The method of claim 20, further comprising:
releasably securing at least one of the first and second sensing components by a method that does not require forming holes in the container enclosure portion or the door.
